(19) United States
(12) Patent Application Publication
(10) Pub. No.: US 2009/0268201 A1
(43) Pub. Date: Oct. 29, 2009

(54) INTEGRATED MOLD DETECTOR

(76) Inventor: Patrick Call, Albuquerque, NM (US)

Correspondence Address: RODEY, DICKASON, SLOAN, AKIN & ROBB, PA, P.O. BOX 1888, ALBUQUERQUE, NM, 87103, US

(21) Appl. No.: 12/299,185

(22) PCT Filed: May 1, 2007
(86) PCT No.: PCT/US07/10747

§ 371 Date: Oct. 31, 2008

Related U.S. Application Data
(60) Provisional application No. 60/796,611, filed on May 1, 2006.
(60) Provisional application No. 60/796,612, filed on May 1, 2006.

(51) Int. Cl. G01N 21/49

(52) U.S. Cl. 356/338

(57) ABSTRACT

A handheld device for detecting the presence of biological and chemical airborne particles. The device collects a sample by drawing air in through a filter that allows air t pass through but collects particles in the air that are larger than the pore size of the filter, which may be selected to meet the user's needs. The filter is then subjected to an optical detection assembly that utilizes UV light directed on the filter and detects visible light emitted by any collected particles via a photomultiplier tube. Prior to collecting a sample, the filter is subjected to the optical detection assembly to generate a baseline reading, which is compared with the test results of the collected sample to determine the presence or absence of particles, such as mold.

### RELATED APPLICATIONS

The present application claims priority to and the benefit of U.S. Provisional Application No. 60/795,611 entitled “Method for sampling for airborne or surface particles” filed on May 1, 2006, which is hereby incorporated by reference in its entirety, and U.S. Provisional Application No. 60/795,612 entitled “Method for collecting and detecting airborne bacteria and fungi” filed on May 1, 2006, which is hereby incorporated by reference in its entirety.

### FIELD OF THE INVENTION

The present invention relates to biological detection equipment, and more particularly to a method and apparatus for detecting mold and other airborne particles.

### BACKGROUND OF THE INVENTION

The air inside of buildings and other structures is typically contaminated with biological and chemical particles, some of which may adversely affect the health of any person inhaling them. Sometimes these biological and chemical particles are present in the air due to being exhaled or introduced into the environment by other persons. Other times these particles are introduced by materials or conditions present in a building or other structure. For example, humidity, reduced ventilation and HVAC systems assist the growth and propagation of biological particles.

To protect persons from illness caused by inhaling hazardous biological and chemical particles, systems have been developed to detect the particles. Some automated continuous collection systems have been developed that utilize wet-walled collectors. Other methods employ dry filter devices that are then manually collected, transported to a laboratory, and then analyzed, which is the method used by existing-hand-held detection devices. A number of prior art devices will now be described.

U.S. Patent Publication No. 2006/0257853 for Herman discloses a detection system including a collector, a control system, a first device for determining the identity of a first particle, and a second device for determining the class of a second particle. The system recovers particles from a filtration device by washing to create a liquid sample. The detection system disclosed is not handheld, as it may be in a range of about 40 pounds to about 60 pounds, as disclosed. Additionally, the system does not disclose a portable, integrated detector for both testing a sample and retaining the sample for later laboratory testing if desired.

U.S. Pat. No. 6,629,932, to Weber et al. discloses a device that continually monitors and records irritants in the air. The device draws air through a sampling port and into a sensor module. The sensor module includes a filter to block large particles and then a detection stage that includes an optical detector that measures the light transmitted, an impedance sensor, and a fluorescence sensor. The air is then ejected from the device by passing it through a filter that collects particles such that the sensor module can be removed and analyzed in a laboratory. The disclosed system looks at each particle individually and uses a filter to collect particles on the back end of the system for later laboratory analysis as part of a continuous monitoring system. However, the system does not disclose a portable, hand-held integrated detector that uses a filter for primary collection and testing of discreet individual samples, and both tests a dry sample and retains the sample for later laboratory testing if desired.

U.S. Patent Application Publication No. 2004/0002126 for Houde et al. discloses an on-site and continuous device for detecting and/or monitoring the presence of microorganisms in an environment. The method disclosed is of capturing microorganisms with a filter for an air sample, recovering from the filter with a liquid under a rolling circle or fluid dripping principle any microorganisms captured, and the analyzing the sample. However, the system does not disclose a portable, hand-held integrated detector that collects and tests discreet individual samples, and both tests a dry sample and retains the sample for later laboratory testing if desired.

### SUMMARY OF THE INVENTION

The present invention is a handheld device for detecting the presence of biological and chemical airborne particles. The device collects a sample by drawing air in through a filter that allows air to pass through but collects particles in the air that are larger than the pore size of the filter, which may be selected to meet the user's needs. The filter is then subjected to an optical detection assembly that utilizes UV light directed on the filter and detects visible light emitted by any collected particles (fluorescence) via a photomultiplier tube. Prior to collecting a sample, the filter is subjected to the optical detection assembly to generate a baseline reading, which is compared with the test results of the collected sample to determine the presence or absence of particles, such as mold.

### DESCRIPTION OF ATTACHED FIGURES AND PICTURES

FIG. 1 is a perspective view of the assembled present invention.

FIG. 2 is a perspective view of the pump utilized in the present invention.

FIG. 3 is a perspective sectional view of one embodiment of the cartridge of the present invention.

FIG. 4 is a perspective sectional view of one embodiment of the cartridge of the present invention located within a flip-top vial for storage purposes (flip-top not depicted).

FIG. 5 is a schematic of the preferred optical system of the present invention.

FIG. 6 is a schematic of an alternative optical detection system interacting with the cartridge of the present invention.

FIG. 7 is a schematic of an alternative dimensioned (in millimeters) design of the optical system of the present invention.

FIG. 8 is a schematic of one embodiment of the layout of the printed control board and its interrelation to other elements of the present invention (standard components, such as a microcontroller, voltage regulators, resistors, capacitors, etc. are not depicted).

FIG. 9 is a perspective view of the present invention wherein the integrated control panel is visible.

### DESCRIPTION OF PREFERRED EMBODIMENT OF THE INVENTION

With reference to the figures, the present invention will now be described. The present invention is an integrated biological and chemical particle detector that is handheld and portable such that it may be carried from one location to another, or room to room, and sample and test a number of different locations with relative ease. The invention tests the samples on-the-spot and also retains them for further laboratory testing. This has the benefit over the prior art of providing an immediate notification in the field of a dangerous or potentially dangerous situation, rather than having to wait for the completion of remote testing to be advised of the situation. This invention is first intended for mold detection in homes and buildings by mold inspectors, but is not limited in application to such circumstances. Instrument 8 is designed to test a sample collected on filter 34 and give a reading relative to the quantity of particles collected, relying on a “baseline” versus “test” comparison.

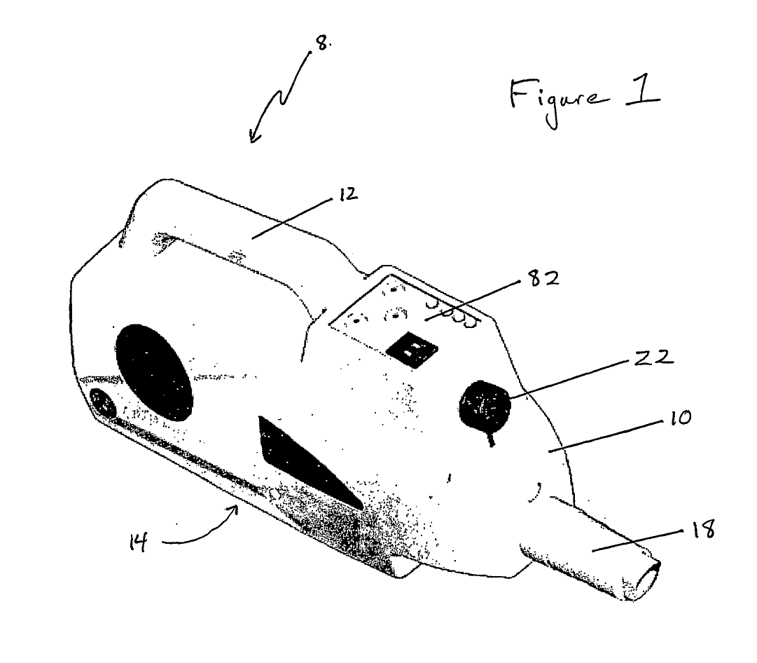

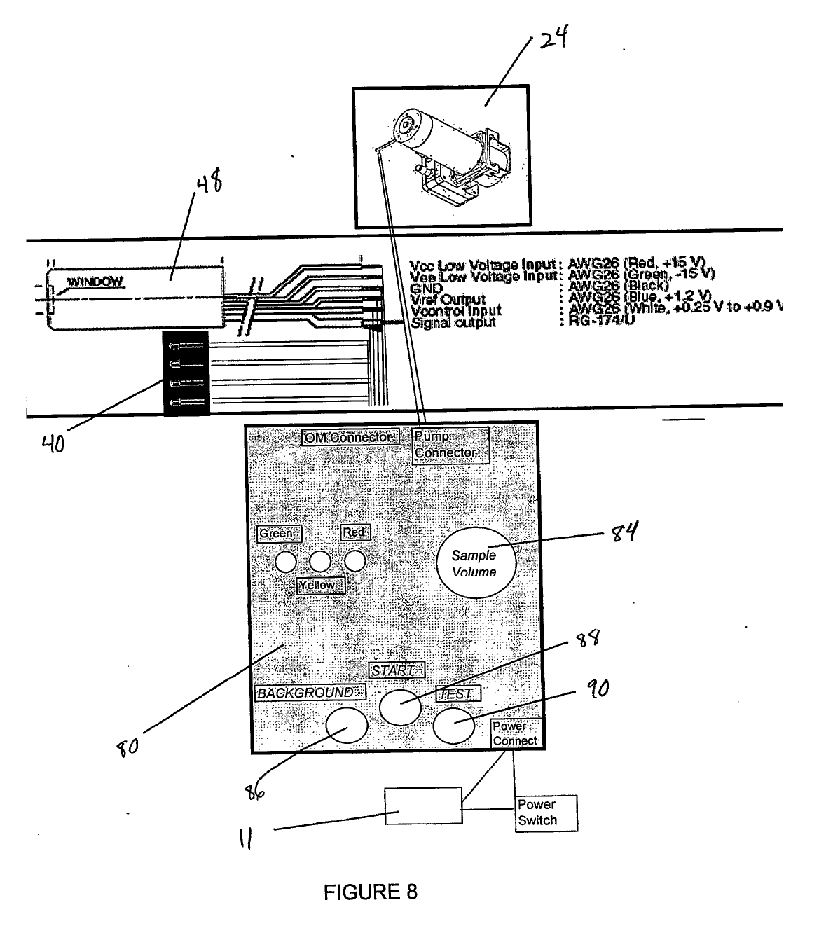

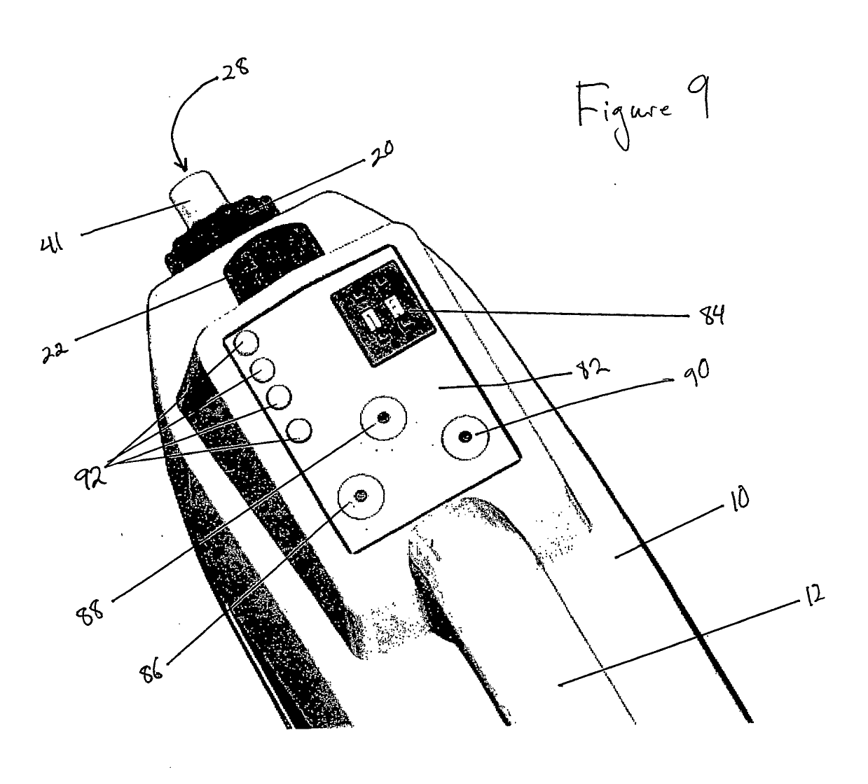

With reference to FIG. 1, instrument 8 of the present invention includes a housing 10 that contains the detection system described herein. Housing 10 is preferably sealed against intrusion from ambient light and formed from molded plastic in a shape that is conducive to hand-held use in the field, with a handle 12 and a substantially flat bottom 14. Control panel 82 is seated at the top of housing 10 and serves as a user input and output for controlling and monitoring the functioning of instrument 8 as discussed herein. FIG. 1 depicts an optional nozzle attachment 18 on the front of housing 10 that aids in sampling air from small cavities and confined areas in a structure, as nozzle 18 may assist in collecting samples from such areas. Nozzle 18 is removably affixed to housing 10 by interfacing with a nozzle ring 20 that is visible in FIG. 9 via a press fit. Cap 22, which is preferably a neoprene cap, removably covers the opening to the optical chamber of the instrument. The optical chamber is designed such that cartridge 30 (described herein) can be inserted and functionally received into the optical chamber for testing of a sample collected on filter 34 of cartridge 30. Thus, the optical chamber is preferably shaped to functionally complement the dimensions of cartridge 30 such that the introduction of ambient light into the optical chamber is inhibited when cartridge 30 is received in the optical chamber. The introduction of ambient light is also inhibited by cap 22, which is put back on to cover the optical chamber opening after inserting cartridge 30 prior to running a test on a collected sample. Also hidden by nozzle 18 is sampling chamber 28 that feeds through nozzle ring 20, as depicted in FIG. 9. A power source 11 (see FIG. 8) is also contained within housing 10. The preferred power source is a rechargeable 24V DC Nickel Metal Hydride cell battery made by Makita (model #193740-8) with 3.3 Amp-Hr performance. The battery is integrated into the instrument, with recharging plugs (not depicted) fixed on housing 10 for easy access while instrument 8 is set on a flat surface. One example of an alternative power source is a Milwaukee 28-volt lithium ion cell battery with a 3.0 Amp-Hr capacity and a built-in level indicator. Alternatively, instrument 8 could be powered through a cord connected to an electrical outlet, but a portable, integrated power source is preferred.

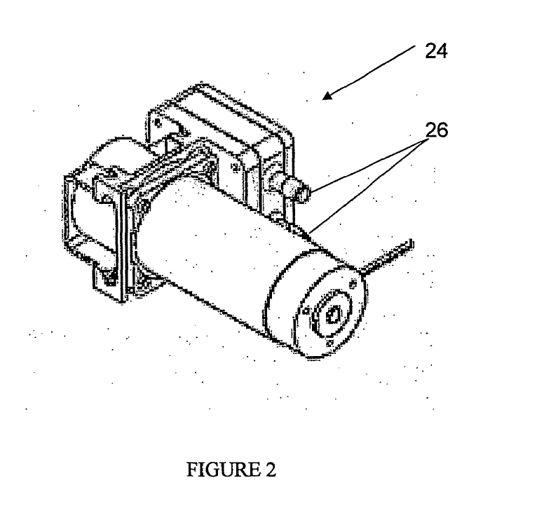

Located within housing 10 is pump 24 that draws air into instrument 8 through sampling chamber 28 when collecting a sample. With reference to FIG. 2, pump 24 is preferably an off-the-shelf unit similar to a pump manufactured by T-Squared Pumps. Pump 24 is selected for optimizing the flow rate and the given pressure constraints while minimizing power consumption. In the preferred embodiment, a Single Head T201 pump by T-Squared Pumps is utilized that has ⅜-inch hose barbs 26 for connection with inlet and outlet lines (not depicted). Within housing 10, pump 24 is connected to sampling chamber 28 such that activating pump 24 will pull air from the surrounding environment in through chamber 28. The activation and operation of pump 24 is controlled by PCB 80 and control panel 82, described herein.

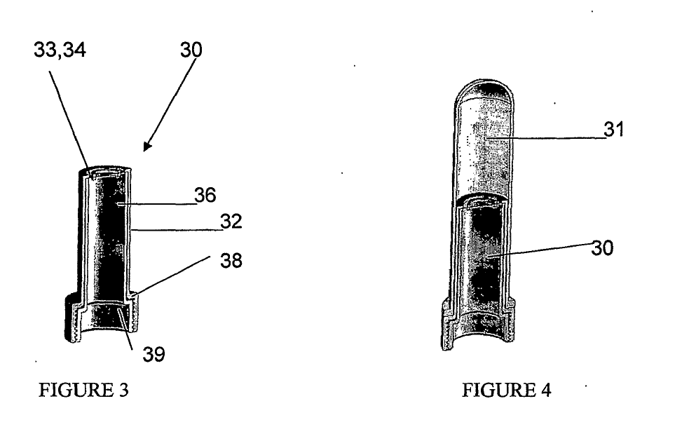

With reference to FIGS. 3 and 9, the present invention collects an air sample via inserting cartridge 30 into sampling chamber 28 and activating pump 24 for a desired period of time depending on a variety of factors (e.g. pump 24 flow rate, size of room being sampled, air quality, type of particles being monitored or detected, filter 34 characteristics, etc.). Cartridge 30 includes cartridge housing 32, filter 34, and filter holder 36. Filter 34 is held between cartridge housing 32 and filter holder 36, as holder 36 slides inside of and is secured in housing 32. Cartridge housing 32 is tubular in shape with shoulder 38 to serve as a depth-stop when cartridge 30 is inserted into the optical chamber (not depicted) behind cap 22. Housing 32 is molded from nonfluorescing plastic and has an diameter of preferably 14 mm to allow cartridge 30 to fit within flip-top vial 31 (see FIG. 4) for storage purposes before and after sample collection, such as the Millipore cat#SE3M098J5 flip-top vial. The preferred cartridge 30 is a disposable, 3-piece plastic cartridge that is molded from a material that does not autofluoresce when excited in the UV light spectrum, wherein the surface of filter 34 is predominantly unobstructed to allow for particle collection. In the preferred embodiment, a filter is placed at one end of a cartridge housing and a filter holder in the form of a cap with an aperture through its center is snapped into place over the end of the cartridge housing such that the cap secures the filter to the cartridge housing around the perimeter of the filter.

Filter 34 is preferably a 13 mm glass fiber membrane filter of a disc shape with a coating to maximize UV fluorescence output for a sample of particles collected on filter 34. Filter 34 is chosen based on the desired pore size wherein particles are captured but air is allowed to pass through, and filter 34 has a non-smooth surface to enhance the capture of particles while still allowing easy extraction of particles through a centrifugal wash technique (“wet” sample collection). Filter 34 has a preferable range of pore sizes from 0.3 microns to 6 microns, and some possible materials include polycarbonate, polyethylene, polypropylene, nylon, glass fiber, metal mesh, and Teflon. Filter 34 may also be made from a material that can dissolve in a liquid to assist in complete particle extraction under “wet” sample testing.

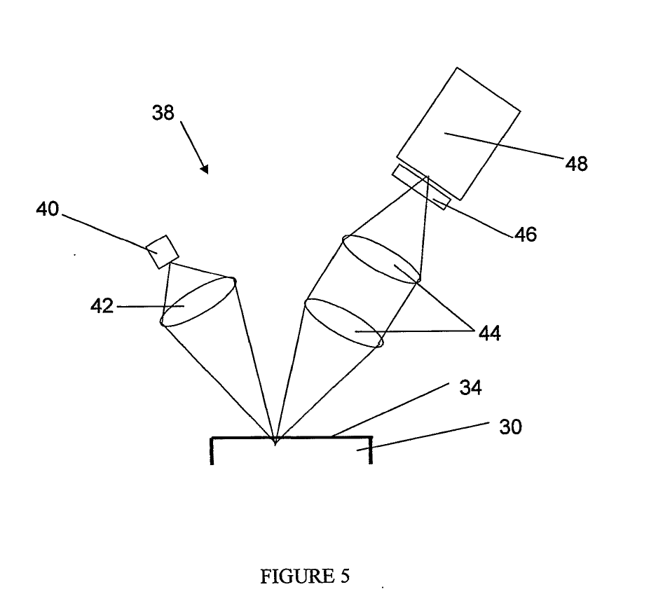

Instrument 8 includes an optical detection system located within housing 10 to provide test readings on samples in the field without requiring transport of the samples to a laboratory. The optical detection system utilizes UV fluorescence to detect and count captured particles collected on filter 34, such as mold. With reference to the preferred embodiment depicted in FIG. 5, optical subassembly 38 is contained within housing 10 and includes a UV-light source 40 and condenser lens 42 to focus the light on filter 34 of cartridge 30. Subassembly 38 also includes collection lenses 44 and UV-filter 46 through which fluorescing light passes prior to entering light detector 48, which is a visible light detector. Any of a number of alternative optical subassembly designs are possible, so long as they include the necessary filters, mirrors and lenses to detect biological and/or chemical pathogens captured on filter 34.

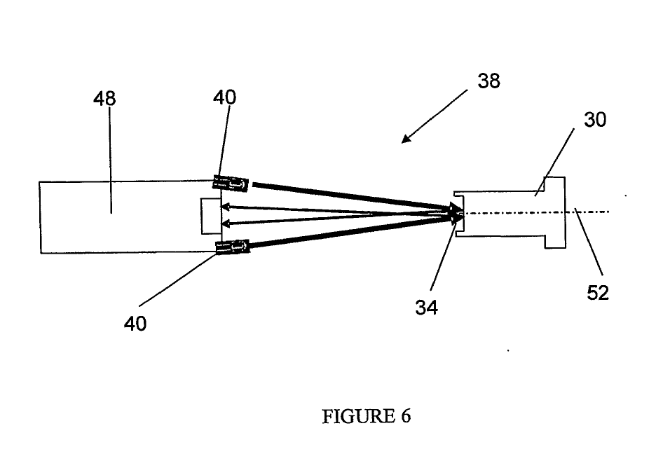

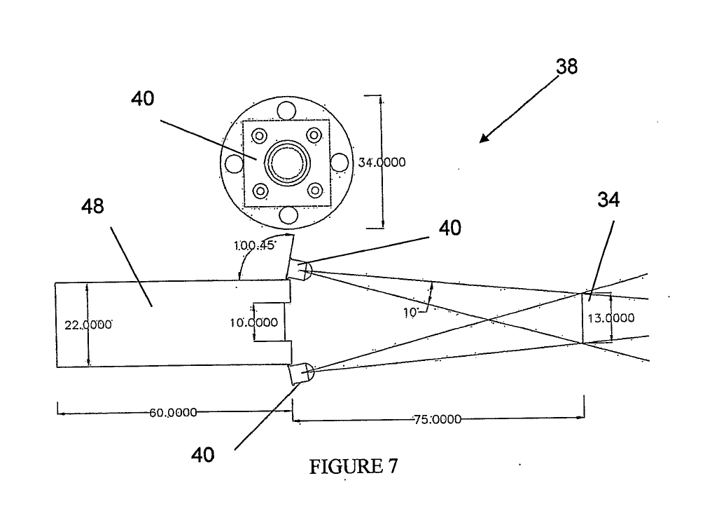

Looking at FIG. 6, which depicts an alternative optical subassembly embodiment, UV-light sources 40 (LEDs in the preferred embodiment and this alternative embodiment) are placed in front of detector 48 to minimize the angle of incidence on filter 34, as depicted. More specifically, four LEDs are placed in front of detector 48 and oriented such the leads of the LEDs are just in front of the plain of detector 48 that first receives reflected light. Having the LEDs in front of the detector will lower the angle giving a more direct line to filter 34 (as opposed to placing the LEDs such that they approach filter 34 from a wider angle. To further reduce the angle of incidence on filter 34, the LEDs may be focused to a point on filter 34 which is 8 mm from the opposite edge of filter 34 (i.e. the focus point lies on the side of centerline 52 of filter 34 that is the same as the LED) which allows the light emitted from the LED to travel in a more direct path to detector 48. The optical subassembly embodiment of FIG. 6 is set forth in dimensioned detail in FIG. 7, including a front view of UV-light source 40 (LED).

Detector 48 is preferably a photomultiplier tube (PMT), which is an extremely sensitive detector of light in the ultraviolet, visible, and near infrared spectrums. Detector 48 is preferably a PMT such as those supplied by Hamamatsu (Photosensor Module model #H5784) with an integrated amplifier that converts electrical current from the fluorescense into a voltage for signal processing by the microcontroller. This detector can multiply a signal produced by incident light by as much as 10⁸, allowing single photons to be resolved. The detector utilized in the present invention can be substituted to meet the detection needs of a specific situation. Additionally, the present invention may include an integrated passive chemical detector (not depicted) for monitoring for CO or VOCs. A photoionization detector (PID) (also not depicted) may be used to detect VOCs, for example. Other chemical detectors could be used in a similar manner in a stand-alone capacity or in conjunction with biological detectors.

The present instrument utilizes a printed control board (PCB) to operate as described, and any of a number of PCB layouts may accomplish the necessary functions for operating instrument 8. With reference to FIG. 8, PCB 80 is powered by a 24V source (power source 11 as discussed above) to run detector 48, UV-light sources 40, and pump 24, as well as the necessary control functions. The PCB utilizes a microcontroller (microprocessor) that is imaged with upgradeable firmware for dictating and controlling the functioning of instrument 8. The user interface (control panel 82) is located directly above PCB 80, which is located within housing 10. Detector 48 preferably remains off unless turned on by pressing the BACKGROUND 86 or TEST 90 buttons, which preferably have a built in delay requiring that they be depressed for a duration of at least one second to activate. Keeping detector 48 otherwise off protects it from damage that may be incurred by measuring too many photons for too long of a duration. A similar safety feature is built in such that detector 48 turns off automatically if the voltage output exceeds the maximum of the detector (15V in the preferred embodiment). In the latter situation, detector 48 would preferably require that either the BACKGROUND 86 or TEST 90 buttons be depressed for at least one second to turn back on.

Control panel 82 is depicted in FIG. 9 as integrated into housing 10, and control 82 functions in conjunction with PCB 80. Sample volume switch 84 is used to select the volume of air to be sampled and is preferably a rotary switch, such as that made by ITT Industries model #RTAP36110SSD25S, PCB mount switch with 36 degree no stop. After setting the desired volume of air sample, the microcontroller converts the sample volume into a set time to run pump 24 from a preprogrammed curve fit formula based on the change in the flow rate over time as filter 34 becomes clogged with particles in the sampled air. Alternatively, the functioning of switch 84 may be based on the total time of sampling desired, rather than the volume of the sample. BACKGROUND button 86, START button 88, and TEST button 90 are momentary pushbutton switches from E-Switch, model #RP3502B-Blk, and are mounted on PCB 80. Mounting specifications for these buttons are located at http://spec/e-switch/com/F-D/F030013.pdf, which is hereby incorporated by reference. Indicator LEDS 92 are standard 5 mm diameter cans. The detection output from detector 48 is converted by the microcontroller and results in the following indicators on control panel 82: (1) solid green LED—power on and all systems ready; (2) all LEDs blinking—a background or rest measurement is in progress (optical module should not be opened during this time); (3) blinking green LED—background measurement accepted and instrument 8 ready to sample, and the LED continues to blink through the duration of the sample until cartridge 30 is placed back in instrument 8 for a test measurement at the optical chamber (if LED changes to solid green, there is no noticeable amount of viable particles in the sample); (4) blinking orange LED—test results indicate an elevated amount of potentially hazardous particles in the air in that location; (5) solid orange LED—the test results indicate a very high level of potentially hazardous particles in the air in that location; and (6) solid red LED—the test results indicate an extremely high level of potentially hazardous particles in the air in that location. Additionally, a fourth LED may be used in connection with a chemical detector (ex. a PID) to indicate the presence of unwanted chemical particles (such as VOCs).

Also depicted in FIG. 9 is nozzle ring 20 and sampling chamber 28 located on the front of instrument 8, as well as sampling chamber extension 41. As discussed previously, nozzle ring 20 is utilized for connecting various attachments to instrument 8 that aid in collecting samples in difficult-to-reach spaces. Sampling chamber 28 is an inlet to instrument 8 through which a cartridge 30 is loaded when an air sample is to be taken. Sampling chamber extension 41 is sized such that the interior portion of cartridge 30 including shoulder 38 (the wider portion, 39) may functionally be seated on tube 41 with filter 34 exposed to the environment outside of housing 10, as discussed below. Then, the orientation of cartridge 30 is reversed to be placed into the optical chamber behind cap 22 for testing such that filter 34 is inserted into the optical chamber to allow detector 48 to test filter 34 for particles.

The present invention is used in the field by (1) loading cartridge 30 (with filter 34) into the optical chamber on the instrument such that ultimate test surface 33 of filter 34 is facing the optical detection subassembly 38 within housing 10 and pressing the “BACKGROUND” button to cause optical subassembly 38 to generate a baseline reading of filter 34 prior to sample collection, (2) loading the disposable cartridge and filter onto sampling chamber extension 41 with the portion 39 of cartridge 30 seated on sampling chamber extension 41 such that ultimate test surface 33 of filter 34 is facing out to the environment such that air will be pulled through filter 34 and deposit particles on ultimate test surface 33, (3) setting the switch to the total amount of air to be sampled (or the total time for sampling desired) and pressing the START button, and (4) after the sampling has completed, removing the disposable cartridge and filter and reinserting it into the optical chamber on the instrument such that ultimate test surface 33 of filter 34 is facing the optical detection subassembly 38 within housing 10 for a reading of the total amount of biological particles present in the sample as compared to the initial baseline reading.

Instrument 8 may also incorporate a wireless transmission subassembly for communicating with a remote location. For example, instrument 8 could not only relay the results of testing, but could also relay a log of each sample taken and relevant information (such as duration of sample, time of day, baseline reading, test reading, etc.). A GPS device may be integrated with instrument 8 to provide location data, or alternatively, a GPS device may be included on cartridge 30 to allow for tracking and chain-of-custody documentation of each individual sample. Similar tracking and locating methods may also be employed in the context of the present invention. For example, a passive RFID (radio frequency identification) tag or chip may be attached to each cartridge 30 to record relevant sampling information as discussed above. Instrument 8 may also be mounted on a tripod or other similar support, and the flat underside 14 of housing 10 may be preconfigured to allow such adaptation. Finally, given the relatively delicate nature of some of the components of instrument 8, a protective case may be included for protection and transport of instrument 8 and extra components and accessories.

Whereas the figures and description have illustrated and described the concept and preferred embodiment of the present invention, it should be apparent to those skilled in the art that various changes may be made in the form of the invention without affecting the scope thereof. The detailed description above is not intended in any way to limit the broad features or principles of the invention, or the scope of patent monopoly to be granted.

What is claimed is:

1. A handheld device for detecting the presence of biological particles in an air sample comprising:
(a) an optical detection assembly comprising a UV light source and a visible light detector;
(b) a pump for drawing air into said handheld device;
(c) a means for controlling the operation of said optical detection assembly and said pump;
(d) a housing holding said optical detection assembly, said pump, and said means for controlling integrated within said housing; and
(e) wherein said device is adapted to collect a sample, test said sample with said optical detection assembly, and retain said sample for further testing.

2. The handheld device of claim 1 wherein said housing includes a first chamber for receiving said sample collected by said device, said first chamber oriented such that said sample is received in an orientation relative to said optical detection assembly wherein said UV light source is positioned to direct UV light onto said sample and said visible light detector is positioned to detect light emitted by said sample.

3. The handheld device of claim 2 wherein said housing includes a second chamber through which said pump draws air into said housing.

4. The handheld device of claim 3 further including a cartridge comprising a filter, and wherein said second chamber is adapted to receive said cartridge such such that said air passes through said filter causing any particles in said air to be deposited on said filter.

5. The handheld device of claim 4 wherein said filter releases said deposited particles under a wet wash.

6. The handheld device of claim 4 wherein said cartridge comprises an outer cartridge housing, an inner filter holder, and said filter.

7. The handheld device of claim 4 wherein said cartridge is a tube with said filter covering a first end of said tube, said filter secured to said tube around the perimeter of said filter such that the surface of said filter is unobstructed other than at its perimeter.

8. The handheld device of claim 4 wherein said cartridge further comprises a radio frequency identification tag.

9. The handheld device of claim 4 wherein said cartridge further comprises a global positioning system device.

10. The handheld device of claim 1 further comprising a global positioning system device integrated within said housing.

11. The handheld device of claim 1 wherein said housing is mountable on a tripod.

12. The handheld device of claim 1 further comprising a passive chemical detector integrated within said housing.

13. The handheld device of claim 12 wherein said passive chemical detector is photo ionization detector.

14. The handheld device of claim 1 wherein said housing is sealed against intrusion from ambient light.

15. The handheld device of claim 1 wherein said visible light detector is a photomultiplier tube.

16. The handheld device of claim 1 further comprising a wireless transmission subassembly for transmitting data to a remote location.

17. A method of detecting the presence of particles in an air sample comprising the steps of:
(a) generating a baseline test of a filter for the presence of biological particles prior to collecting a sample;
(b) collecting said sample by drawing air through said filter such that a surface of said filter collects particles in said air;
(c) testing said sample for the presence of biological particles;
(d) comparing said baseline test with said test of said sample for the difference in the number of biological particles present in said baseline test and test of said sample.

18. The method of claim 17 wherein said step of generating, said step of collecting, said step of testing, and said step of comparing are performed by a single handheld detection unit in the field.

19. The method of claim 17 further comprising the step of retaining said sample after said step of testing for further testing in an off-site testing facility.

20. The method of claim 17 wherein said steps of generating and testing are performed by directing UV light onto said surface of said filter and detecting the fluorescence of particles collected on said surface without creating a liquid sample.
